(19) United States
(12) Patent Application Publication
(10) Pub. No.: US 2014/0019685 A1
(43) Pub. Date: Jan. 16, 2014

(54) Method and Apparatus for Processing RAID Configuration Information and RAID Controller

(71) Applicant: Huawei Technologies Co., LTD, Shenzhen (CN)

(72) Inventors: Huabing Ling, Shenzhen (CN); Jiangtao Li, Shenzhen (CN); Rong Luo, Shenzhen (CN); Zhijun Wei, Shenzhen (CN)

(73) Assignee: Huawei Technologies Co., LTD, Shenzhen (CN)

(21) Appl. No.: 14/032,378

(22) Filed: Sep. 20, 2013

Related U.S. Application Data
(63) Continuation of application No. PCT/CN2011/078114, filed on Aug. 8, 2011.

(51) Int. Cl. G06F 3/06

(52) U.S. Cl. CPC G06F 3/0689; G06F 3/0619; G06F 3/0664
USPC 711/114

(57) ABSTRACT

Embodiments of the present invention relate to a method and an apparatus for processing RAID configuration information, and a RAID controller. The RAID includes a number of hard disks. The method includes detecting whether a new hard disk exists in the plurality of hard disks. When it is detected that the new hard disk exists in the plurality of hard disks, writing the pre-configured RAID configuration information corresponding to its hard disk number to the new hard disk, so that the new hard disk becomes a hard disk in the RAID.

### CROSS-REFERENCE TO RELATED APPLICATIONS

This application is a continuation of International Application No. PCT/CN2011/078114, filed on Aug. 8, 2011, which is hereby incorporated by reference in its entireties.

### TECHNICAL FIELD

The present invention relates to communications technologies, and in particular, to a method and an apparatus for processing redundant array of independent disk (RAID) configuration information, and a RAID controller.

### BACKGROUND

A redundant array of independent disk (RAID) is a hard disk group (logical hard disk) formed by combining a plurality of independent hard disks (physical hard disks) in different manners. The RAID may use a striping technology to distribute data to each hard disk. Each stripe may be viewed as a logical unit (LU), and may use a logical unit number (LUN) for identification. Each logical unit is scattered to a continuous block. Data is divided into a plurality of blocks ranging from 512 bytes to several megabytes, and then respectively written to a corresponding position in each hard disk. In the RAID, a hard disk corresponding to any hard disk number may be replaced with a new hard disk.

However, after the new hard disk takes the place in the RAID, an operator needs to configure RAID configuration information corresponding to a hard disk number of the new hard disk to the new hard disk, operating time is long, and an error occurs easily, thereby resulting in reducing reliability of the RAID configuration information.

### SUMMARY OF THE INVENTION

Embodiments of the present invention provide a method and an apparatus for processing RAID configuration information, and a RAID controller, which are used to solve a problem that reliability of the RAID configuration information is low in the prior art.

According to one aspect, the present invention provides a method for processing RAID configuration information, where the method is applied to a RAID, and the RAID includes a plurality of hard disks. The method includes detecting whether a new hard disk exists in the plurality of hard disks. Information stored in the new hard disk does not accord with pre-configured RAID configuration information corresponding to a hard disk number of the new hard disk. When it is detected that the new hard disk exists in the plurality of hard disks, writing the pre-configured RAID configuration information corresponding to its hard disk number to the new hard disk.

According to another aspect, the present invention provides an apparatus for processing RAID configuration information, where the apparatus is applied to a RAID, and the RAID includes a plurality of hard disks. The apparatus includes a detecting unit, which is configured to detect whether a new hard disk exists in the plurality of hard disks. Information stored in the new hard disk does not accord with pre-configured RAID configuration information corresponding to a hard disk number of the new hard disk. A configuring unit is configured to when the detecting unit detects that the new hard disk exists in the plurality of hard disks, write the pre-configured RAID configuration information corresponding to its hard disk number to the new hard disk.

An embodiment of the present invention also provides a RAID controller, including the foregoing apparatus for processing RAID configuration information.

It can be known from the foregoing technical solutions that, according to the embodiments of the present invention, whether the new hard disk, whose stored information does not accord with the pre-configured RAID configuration information corresponding to its hard disk number, exists in a plurality of hard disks that form a RAID is detected, and when it is detected that the foregoing new hard disk exists in the plurality of hard disks, the pre-configured RAID configuration information corresponding to its hard disk number is written to the foregoing new hard disk, so that the foregoing new hard disk becomes a hard disk in the foregoing RAID, which can avoid problems that operation time is long and an error easily occurs in the prior art, where the problems are caused by manually configuring, by an operator, RAID configuration information corresponding to a hard disk number of a new hard disk to the new hard disk, thereby improving the reliability of the RAID configuration information.

### BRIEF DESCRIPTION OF THE DRAWINGS

To illustrate the technical solutions in the embodiments of the present invention or the prior art more clearly, accompanying drawings that need to be used in the description of the embodiments or the prior art are briefly introduced below. Obviously, the accompanying drawings in the following description are merely some embodiments of the present invention. Persons of ordinary skill in the art may further obtain other drawings according to these accompanying drawings without making creative efforts.

FIG. 1 is a schematic flowchart of a method for processing RAID configuration information according to an embodiment of the present invention;

FIG. 2 is a schematic flowchart of a method for processing RAID configuration information according to another embodiment of the present invention;

FIG. 3 is a schematic structural diagram of an apparatus for processing RAID configuration information according to another embodiment of the present invention; and

FIG. 4 is a schematic diagram of a system to which the embodiment corresponding to FIG. 2 applies.

### DETAILED DESCRIPTION OF ILLUSTRATIVE EMBODIMENTS

To make the purposes, technical solutions, and advantages of the embodiments of the present invention more clearly, the technical solutions in the embodiments of the present invention are clearly and completely described with the accompanying drawings in the embodiments of the present invention. Evidently, the embodiments to be described are part of rather than all of the embodiments of the present invention. All other embodiments obtained by persons of ordinary skill in the art based on the embodiments of the present invention without making creative efforts shall fall within the protection scope of the present invention.

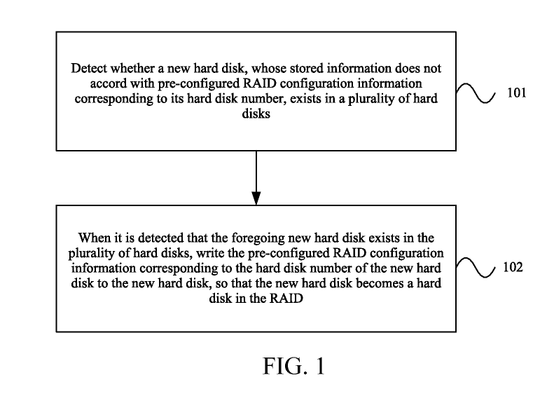

FIG. 1 is a schematic flowchart of a method for processing RAID configuration information according to an embodiment of the present invention. The method for processing RAID configuration information in this embodiment may be applied to a RAID, where the RAID may include a plurality of hard disks. The method for processing RAID configuration information in this embodiment may include the following steps.

101: Detect whether a new hard disk, whose stored information does not accord with pre-configured RAID configuration information corresponding to its hard disk number, exists in the plurality of hard disks. For example, information stored in a designated area of the plurality of hard disks may be detected to determine whether the foregoing new hard disk exists. For another example, according to a hard disk insertion event, information stored in a designated area of a hard disk corresponding to the foregoing hard disk insertion event may also be detected to determine whether the foregoing new hard disk exists. Information stored in a designated area of the foregoing new hard disk does not accord with the pre-configured RAID configuration information corresponding to its hard disk number. It may be understood that the foregoing “new hard disk” not only refers to an unused hard disk, but also refers to a newly-inserted hard disk that is different from a hard disk that is removed previously.

That the information stored in the designated area of the new hard disk does not accord with the pre-configured RAID configuration information corresponding to its hard disk number may include the following two cases:

A. If the information stored in the designated area of the new hard disk is blank content, it indicates that the new hard disk does not belong to any other RAID previously.

B. If the information stored in the designated area of the new hard disk is inconsistent with the pre-configured RAID configuration information corresponding to its hard disk number, it indicates that the new hard disk was a hard disk in another RAID previously.

It may be understood that the foregoing designated area may be a pre-designated fixed area, and is used to store RAID configuration information corresponding to the hard disk number of the hard disk. For example part of the RAID configuration information in the RAID configuration information may be stored in a last sector. Position data stored in the sector may point to other RAID configuration information stored in a corresponding sector (generally speaking, determined by a vendor itself).

102: When it is detected that the foregoing new hard disk exists in the plurality of hard disks, write the pre-configured RAID configuration information corresponding to the hard disk number of the new hard disk to the new hard disk, so that the new hard disk becomes a hard disk in the foregoing RAID.

An executing entity of the foregoing 101 and 102 may be a RAID controller, where the RAID controller may control a hard disk in the RAID to perform read and write operations.

In this embodiment, each hard disk in the RAID corresponds to a group of RAID configuration information. This group of RAID configuration information may include a RAID type (for example, RAID0, RAID1, RAID5, or RAID6), hard disk numbers of all hard disks in the RAID, a read policy (for example, prefetch and cacheable), and a write policy (for example, write-back and cacheable).

If a device includes multiple groups of RAIDs, and each group of RAIDs corresponds to a RAID controller, the foregoing RAID configuration information may further include slot numbers corresponding to the foregoing plurality of hard disks (a slot number of the RAID controller). For example, assume that there are two RAID controllers, namely a RAID controller A and a RAID controller B, the RAID controller A controls hard disks A1 and A2, the RAID controller B controls hard disks B1 and B2, the hard disks A1 and A2 form an RAID0, and the hard disks B1 and B2 form an RAID1.

For the foregoing device, pre-configured configuration information may be expressed as follows:

```
    VirtualDisk: /*start flag of RAID configuration information of the hard disks
A1 and A2*/
    SLOT=0 /*slot number where the RAID controller A is located*/
    RAID=0 /*RAID level, for example: RAID0, RAID1, or RAID5*/
    WRITEPOLICY=write_back /*write policy, for example: write-through or
write-back*/
    READPOLICY=adaptive_read_ahead /*read policy, for example: prefetch, not
prefetch or adaptive prefetch*/
    IOPOLICY=no_cached /*IO policy included in the read policy/write policy,
for example, using a cache or not using a cache*/
    PD=0,1 /*hard disk numbers included in the RAID*/
    VirtualDisk: /*start flag of RAID configuration information of the hard disks
B1 and B2*/
    SLOT=1 /*slot number where the RAID controller B is located*/
    RAID=1 /*RAID level, for example: RAID0, RAID1, or RAID5*/
    WRITEPOLICY=direct /*write policy, for example: write-through or write-
back*/
    READPOLICY=adaptive_read_ahead /*read policy, for example: prefetch, not
prefetch or adaptive prefetch*/
    IOPOLICY=cached /*IO policy included in the read policy/write policy, for
example, using a cache or not using a cache*/
    PD=0,1 /*hard disk numbers included in the RAID*/
```

Before 101, the RAID controller may further configure, according to the pre-configured RAID configuration information, corresponding RAID configuration information in each hard disk in the RAID.

In this embodiment, whether the new hard disk, whose stored information does not accord with the pre-configured RAID configuration information corresponding to its hard disk number, exists in a plurality of hard disks that form a RAID is detected, and when it is detected that the foregoing new hard disk exists in the plurality of hard disks, the pre-configured RAID configuration information corresponding to the hard disk number of the new hard disk is written to the foregoing new hard disk, so that the foregoing new hard disk becomes a hard disk in the foregoing RAID, which can avoid problems that operation time is long and an error easily occurs in the prior art, where the problems are caused by manually configuring, by an operator, RAID configuration information corresponding to a hard disk number of a new hard disk to the new hard disk, thereby improving reliability of the RAID configuration information.

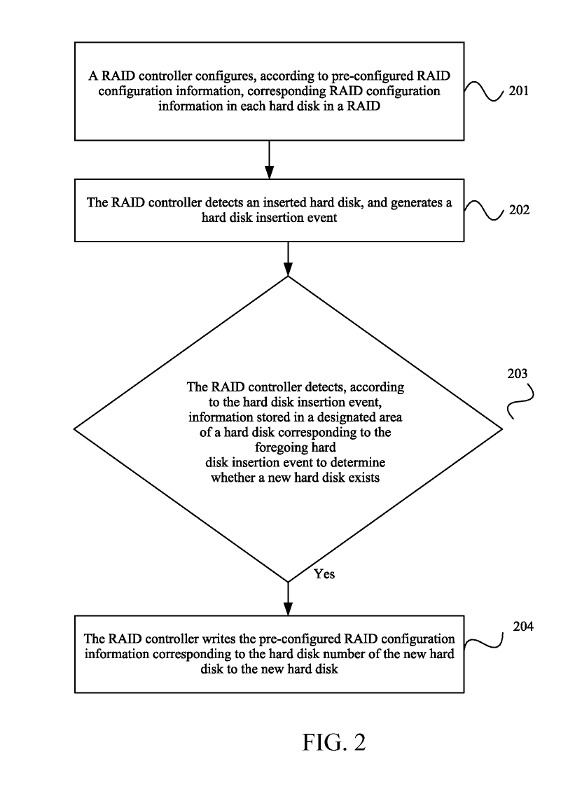

FIG. 2 is a schematic flowchart of a method for processing RAID configuration information according to another embodiment of the present invention. This embodiment is a specific embodiment of the embodiment corresponding to FIG. 1. A function of a RAID controller in this embodiment may be implemented by a processor (for example, a CPU). RAID configuration information is pre-configured in a system, for example, the RAID configuration information is pre-configured in a memory, as shown in FIG. 4. The method for processing RAID configuration information in this embodiment may include the following steps.

201: A RAID controller configures corresponding RAID configuration information in each hard disk in a RAID according to pre-configured RAID configuration information.

202: The RAID controller detects an inserted hard disk, and generates a hard disk insertion event.

203: The RAID controller detects, according to the hard disk insertion event, information stored in a designated area of the hard disk corresponding to the hard disk insertion event to determine whether a new hard disk exists. If yes, 204 is executed; otherwise, the process ends.

Specifically, whether the information stored in the designated area of the hard disk is blank content may be detected. If it is blank content, it indicates that the inserted hard disk does not belong to any other RAID previously, and 204 needs to be executed; if it is not blank content, it may be continued to detect whether the information stored in the designated area of the hard disk is consistent with pre-configured RAID configuration information corresponding to its hard disk number. If consistent, it indicates that the inserted hard disk is a hard disk removed from a position corresponding to a hard disk number of a previously-inserted hard disk, and no operation is needed. If inconsistent, it indicates that the inserted hard disk was a hard disk in another RAID previously, and 204 needs to be executed.

204: The RAID controller writes the pre-configured RAID configuration information corresponding to the hard disk number of the foregoing new hard disk to the foregoing new hard disk, so that the new hard disk becomes a hard disk in the foregoing RAID.

If the information stored in the designated area of the new hard disk is blank content, the RAID controller may directly write the pre-configured RAID configuration information corresponding to the hard disk number of the foregoing new hard disk to the foregoing new hard disk; if the information stored in the designated area of the new hard disk is not blank content, the RAID controller may erase the information first, and then write the pre-configured RAID configuration information corresponding to the hard disk number of the foregoing new hard disk to the foregoing new hard disk.

In this embodiment, by detecting whether the new hard disk, whose stored information does not accord with the pre-configured RAID configuration information corresponding to its hard disk number, exists in a plurality of hard disks that form a RAID, and when it is detected that the foregoing new hard disk exists in the plurality of hard disks, the RAID controller writes the pre-configured RAID configuration information corresponding to the hard disk number of the foregoing new hard disk to the foregoing new hard disk, so that the foregoing new hard disk becomes a hard disk in the foregoing RAID, which can avoid problems that operation time is long and an error easily occurs in the prior art, where the problems are caused by manually configuring, by an operator, RAID configuration information corresponding to a hard disk number of a new hard disk to the new hard disk, thereby improving reliability of the RAID configuration information.

It should be noted that for ease of description, the foregoing method embodiments are expressed as a series of action combinations. However, those skilled in the art should know that, the present invention is not limited by the described action sequences, because according to the present invention, other sequences may be adopted for some steps, or some steps may be implemented simultaneously. Secondly, those skilled in the art should also know that, the embodiments described in the specification are exemplary embodiments, and actions and modules that are involved are not certainly necessary to the present invention.

In the foregoing embodiments, the description of each embodiment has its focus. For part that is not described in a certain embodiment, reference may be made to relevant descriptions in other embodiments.

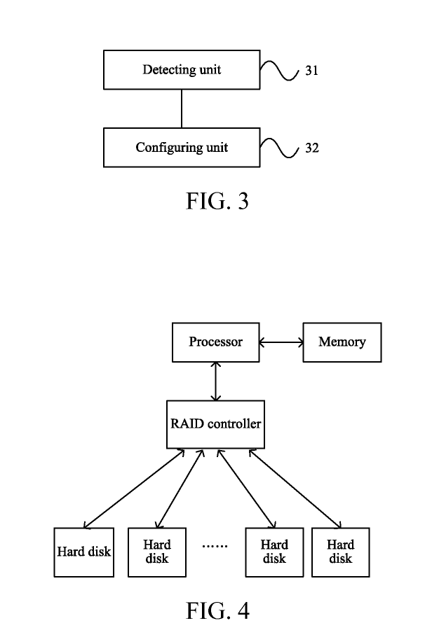

FIG. 3 is a schematic structural diagram of an apparatus for processing RAID configuration information according to another embodiment of the present invention. The apparatus for processing RAID configuration information in this embodiment may be applied to a RAID, where the RAID may include a plurality of hard disks. As shown in FIG. 3, the apparatus for processing RAID configuration information in this embodiment may include a detecting unit 31 and a configuring unit 32. The detecting unit 31 is configured to detect whether a new hard disk, whose stored information does not accord with pre-configured RAID configuration information corresponding to the hard disk number of the foregoing new hard disk, exists in the plurality of hard disks; and the configuring unit 32 is configured to when the detecting unit 31 detects that the foregoing new hard disk exists in the plurality of hard disks, write the pre-configured RAID configuration information corresponding to its hard disk number to the foregoing new hard disk detected by the detecting unit 31, so that the foregoing new hard disk becomes a hard disk in the foregoing RAID.

The foregoing method in the embodiment corresponding to FIG. 1 and the function of the RAID controller in the embodiment corresponding to FIG. 2 may be implemented by the apparatus for processing RAID configuration information in this embodiment.

For example, the detecting unit 31 in this embodiment may specifically detect information stored in a designated area of the plurality of hard disks to determine whether the foregoing new hard disk exists; or detect, according to a hard disk insertion event, information stored in a designated area of a hard disk corresponding to the foregoing hard disk insertion event to determine whether the foregoing new hard disk exists; information stored in a designated area of the foregoing new hard disk does not accord with the pre-configured RAID configuration information corresponding to its hard disk number.

In this embodiment, each hard disk in the RAID corresponds to a group of RAID configuration information. This group of RAID configuration information may include a RAID type (for example, RAID0, RAID1, RAID5, or RAID6), hard disk numbers of all hard disks in the RAID, a read policy (for example, prefetch and cacheable), and a write policy (for example, write-back and cacheable).

If a device includes multiple groups of RAIDs, and each group of RAID corresponds to a RAID controller, the foregoing RAID configuration information may further include slot numbers corresponding to the foregoing plurality of hard disks (that is, a slot number of the RAID controller).

Optionally, the configuring unit 32 in this embodiment may further configure, according to the pre-configured RAID configuration information, corresponding RAID configuration information in the plurality of hard disks.

In this embodiment, the detecting unit detects whether the new hard disk, whose stored information does not accord with the pre-configured RAID configuration information corresponding to its hard disk number, exists in a plurality of hard disks that form a RAID, and when it is detected the foregoing new hard disk exists in the plurality of hard disks, the configuring unit writes the pre-configured RAID configuration information corresponding to the hard disk number of the foregoing new hard disk to the foregoing new hard disk, so that the new hard disk becomes a hard disk in the foregoing RAID, which can avoid problems that operation time is long and an error easily occurs in the prior art, where the problems are caused by manually configuring, by an operator, RAID configuration information corresponding to a hard disk number of a new hard disk to the new hard disk, thereby improving reliability of the RAID configuration information.

Another embodiment of the present invention provides a RAID controller, including the apparatus for processing RAID configuration information provided in the embodiment corresponding to FIG. 3.

Those skilled in the art may clearly understand that, for ease and concision of description, for a specific working process of the foregoing described system, apparatus, and unit, reference may be made to a corresponding process in the foregoing method embodiments, and details are not repeatedly described here.

In the several embodiments provided in this application, it should be understood that, the disclosed system, apparatus, and method may be implemented by other manners. For example, the foregoing described apparatus embodiment is only exemplary. For example, dividing of the units is only a type of dividing of logical functions. In actual implementation, there may be other dividing methods. For example, a plurality of units or components may be combined or integrated into another system, or some features may be ignored, or may not be executed. In addition, the shown or discussed mutual coupling, or direct coupling, or communication connection may be implemented through some interfaces, and indirect coupling or communication connection of apparatuses or units may be electrical, mechanical, or in other forms.

The units that are described as separate components may be or may not be physically separated, and the components shown as units may be or may not be physical units, that is, may be located at one place, or may also be distributed on multiple network units. Part of or all of the units may be selected, according to an actual need, to achieve the purposes of the solutions in the embodiments.

In addition, function units in each embodiment of the present invention may be integrated into a processing unit, and each unit may also exist independently and physically, and two or more than two units may also be integrated into one unit. The foregoing integrated unit may be implemented in the form of hardware, and may also be implemented in the form of hardware plus a software function unit.

The foregoing integrated unit implemented in the form of the software function unit may be stored in a computer readable storage medium. The software function unit is stored in a storage medium, including several instructions used for a computer device (which may be a personal computer, a server, or a network device, and so on) to execute part of the steps of the method in each embodiment of the present invention. The foregoing storage medium includes various media that can store procedure codes, such as a USB disk, a portable hard disk, a read only memory (Read-Only Memory, abbreviated as ROM), a random access memory (Random Access Memory, abbreviated as RAM), a magnetic disk, or a compact disk.

Finally, it should be noted that: The foregoing embodiments are only intended to explain the technical solutions in the present invention, but not intended to limit it. Although the present invention is described in detail with reference to the foregoing embodiments, persons of ordinary skill in the art should understand that, they may still make modifications to the technical solutions recorded in the foregoing embodiments, or equivalent replacements to part of the technical features in the technical solutions recorded in the foregoing embodiments; however, these modifications or replacements do not make the nature of the corresponding technical solutions depart from the spirit and scope of the technical solutions in the embodiments of the present invention.

What is claimed is:

1. A method for processing redundant array of independent disk (RAID) configuration information, wherein the method is applied to a RAID that comprises a plurality of hard disks, the method comprising:
detecting that a new hard disk exists in the plurality of hard disks, wherein information stored in the new hard disk does not accord with pre-configured RAID configuration information corresponding to a hard disk number of the new hard disk; and
in response to detecting that the new hard disk exists in the plurality of hard disks, writing the pre-configured RAID configuration information corresponding to the hard disk number of the new hard disk to the new hard disk.

2. The method according to claim 1, wherein detecting that a new hard disk exists in the plurality of hard disks comprises detecting whether information stored in a designated area of each of the plurality of hard disks is accord with pre-configured RAID configuration information corresponding to hard disk number of each of the plurality of hard disks to determine that the new hard disk exists, wherein information stored in a designated area of the new hard disk does not accord with the pre-configured RAID configuration information corresponding to the hard disk number of the new hard disk to the new hard disk.

3. The method according to claim 2, wherein the information stored in the designated area of the new hard disk is blank content.

4. The method according to claim 2, wherein the information stored in the designated area of the new hard disk is inconsistent with the pre-configured RAID configuration information corresponding to the hard disk number of the new hard disk to the new hard disk.

5. The method according to claim 1, wherein detecting that a new hard disk exists in the plurality of hard disks comprises:
receiving a hard disk insertion event;
determining a new inserted hard disk; and
detecting whether information stored in a designated area of the new inserted hard disk is accord with pre-configured RAID configuration information corresponding to hard disk number of the new inserted hard disk to determine whether the new hard disk exists;
wherein information stored in the designated area of the new hard disk does not accord with the pre-configured RAID configuration information corresponding to the hard disk number of the new hard disk to the new hard disk.

6. The method according to claim 5, wherein the information stored in the designated area of the new hard disk is blank content.

7. The method according to claim 5, wherein the information stored in the designated area of the new hard disk is inconsistent with the pre-configured RAID configuration information corresponding to the hard disk number of the new hard disk to the new hard disk.

8. The method according to claim 1, wherein the RAID configuration information comprises a RAID type, hard disk numbers of the plurality of hard disks, a read policy, and a write policy.

9. The method according to claim 8, wherein the RAID configuration information further comprises slot numbers corresponding to the plurality of hard disks.

10. The method according to claim 1, wherein the method further comprises:
configuring, according to the pre-configured RAID configuration information, corresponding RAID configuration information in the plurality of hard disks.

11. An apparatus for processing redundant array of independent disk (RAID) configuration information, wherein the apparatus is applied to a RAID that comprises a plurality of hard disks, the apparatus comprising:
a detecting unit, configured to detect whether a new hard disk exists in the plurality of hard disks, wherein information stored in the new hard disk does not accord with pre-configured RAID configuration information corresponding to a hard disk number of the new hard disk; and
a configuring unit, configured to write the pre-configured RAID configuration information corresponding to the hard disk number of the new hard disk to the new hard disk when the detecting unit detects that the new hard disk exists in the plurality of hard disks.

12. The apparatus according to claim 11, wherein the detecting unit is specifically configured to detect whether information stored in a designated area of each of the plurality of hard disks is accord with pre-configured RAID configuration information corresponding to hard disk number of each of the plurality of hard disks to determine whether the new hard disk exists, wherein information stored in a designated area of the new hard disk does not accord with the pre-configured RAID configuration information corresponding to the hard disk number of the new hard disk to the new hard disk.

13. The apparatus according to claim 11, wherein the detecting unit is specifically configured to receive a hard disk insertion event, to determine a new inserted hard disk, and to detect whether information stored in a designated area of the new inserted hard disk is accord with pre-configured RAID configuration information corresponding to hard disk number of the new inserted hard disk to determine whether the new hard disk exists, wherein information stored in a designated area of the new hard disk does not accord with the pre-configured RAID configuration information corresponding to the hard disk number of the new hard disk to the new hard disk.

14. The apparatus according to claim 11, wherein the RAID configuration information comprises a RAID type, hard disk numbers of the plurality of hard disks, a read policy, and a write policy.

15. The apparatus according to claim 14, wherein the RAID configuration information further comprises slot numbers corresponding to the plurality of hard disks.

16. The apparatus according to claim 11, wherein the configuring unit is further configured to configure, corresponding RAID configuration information in the plurality of hard disks according to the pre-configured RAID configuration information.

17. A redundant array of independent disk (RAID) controller, comprising a processing unit coupled to a memory, wherein the processing unit is programmed to control a RAID by:
detecting that a new hard disk exists in a plurality of hard disks of the RAID, wherein information stored in the new hard disk does not accord with pre-configured RAID configuration information corresponding to a hard disk number of the new hard disk; and
in response to detecting that the new hard disk exists in the plurality of hard disks, writing the pre-configured RAID configuration information corresponding to the hard disk number of the new hard disk to the new hard disk.

18. The RAID controller according to claim 17, wherein detecting that the new hard disk exists in the plurality of hard disks comprises detecting whether information stored in a designated area of each of the plurality of hard disks is accord with pre-configured RAID configuration information corresponding to hard disk number of each of the plurality of hard disks to determine that the new hard disk exists, wherein information stored in a designated area of the new hard disk does not accord with the pre-configured RAID configuration information corresponding to the hard disk number of the new hard disk to the new hard disk.

19. The RAID controller according to claim 17, wherein detecting that a new hard disk exists in the plurality of hard disks comprises:
receiving a hard disk insertion event;
determining a new inserted hard disk; and
detecting whether information stored in a designated area of the new inserted hard disk is accord with pre-configured RAID configuration information corresponding to hard disk number of the new inserted hard disk to determine whether the new hard disk exists;
wherein information stored in the designated area of the new hard disk does not accord with the pre-configured RAID configuration information corresponding to the hard disk number of the new hard disk to the new hard disk.

20. The RAID controller according to claim 17, wherein the processing unit is further programmed to configuring corresponding RAID configuration information in the plurality of hard disks according to the pre-configured RAID configuration information.
